(19) United States
(12) Patent Application Publication
(10) Pub. No.: US 2015/0169119 A1
(43) Pub. Date: Jun. 18, 2015

(54) Major-Axis Pinch Navigation In A Three-Dimensional Environment On A Mobile Device

(71) Applicant: David Kornmann, Sunnyvale, CA (US)

(72) Inventor: David Kornmann, Sunnyvale, CA (US)

(73) Assignee: Google Inc., Mountain View, CA (US)

(21) Appl. No.: 13/024,831

(22) Filed: Feb. 10, 2011

Related U.S. Application Data
(60) Provisional application No. 61/305,206, filed on Feb. 17, 2010.

(51) Int. Cl. G06F 3/041; G06F 3/0488; G06F 3/0481; G06F 3/01

(52) U.S. Cl. CPC G06F 3/0412; G06F 3/017; G06F 3/0488; G06F 3/04815

(57) ABSTRACT

Embodiments provide new user-interface gesture detection on a mobile device. In an embodiment, a user can zoom-in and zoom-out using a pinch on a mobile device having limited sensitivity to touch position along a minor axis of a gesture. Multi-finger touch gestures, including a pinch zoom gesture, are detected along a major axis even if digits are not properly discriminated on a minor axis.

This patent application claims the benefit of U.S. Provisional Patent Application No. 61/305,206, (Attorney Docket No. 2525.2700000), filed Feb. 17, 2010, entitled “Major-Axis Pinch Navigation in a Three-Dimensional Environment on a Mobile Device.”

### BACKGROUND

1. Field of the Invention

This field generally relates to navigation in a three-dimensional environment.

2. Background Art

Systems exist for navigating through a three-dimensional environment to display three-dimensional data. The three-dimensional environment includes a virtual camera that defines what three-dimensional data to display. The virtual camera has a perspective according to its position and orientation. By changing the perspective of the virtual camera, a user can navigate through the three-dimensional environment.

Mobile devices, such as cell phones, personal digital assistants (PDAs), portable navigation devices (PNDs) and handheld game consoles, are gaining improved computing capabilities. Many mobile devices can access one or more networks, such as the Internet. Also, some mobile devices, such as an IPHONE device available from Apple Inc., accept input from a touch screen that can detect multiple touches simultaneously. However, some touch screens have a low resolution that can make it difficult to distinguish between two simultaneous touches.

Methods and systems are needed that improve navigation in a three-dimensional environment on a mobile device with a low-resolution touch screen.

### BRIEF SUMMARY

Embodiments relate to navigation using a major axis of a pinch gesture. In an embodiment, a computer-implemented method navigates a virtual camera in a three-dimensional environment on a mobile device having a touch screen. In the method, a first user input indicating that two objects have touched a view of the mobile device. The first object touched the view at a first position and the second object touched the view at a second position is received. A first distance between the first and second positions along an x-axis of the view is determined, and a second distance between the first and second positions along a y-axis of the view is determined. A second user input indicating that the two objects have moved to new positions on the view of the mobile device is received. The first object moved to a third position on the view and the second object moved to a fourth position on the view. A third distance is determined to be the distance between the first and second positions along the x-axis of the view if the first distance is greater than the second distance. The third distance is determined to be the distance between the first and second positions along the y-axis of the view if the first distance is less than the second distance. In response to the second user input, the virtual camera is moved relative to the three-dimensional environment according to the third distance and the greater of the first and second distances.

In another embodiment, a system navigates in a three-dimensional environment on a mobile device having a touch screen. The system includes a motion model that specifies a virtual camera to indicate how to render the three-dimensional environment for display. A touch receiver receives a first user input indicating that two objects have touched a view of the mobile device, wherein the first object touched the view at a first position and the second object touched the view at a second position. The touch receiver also receives a second user input indicating that the two objects have moved to new positions, different from the positions in the first user input, on the view of the mobile device, wherein the first object moved to a third position on the view and the second object moved to a fourth position on the view. An axes module determines a first distance between the first and second positions along an x-axis of the view, and a second distance between the first and second positions along a y-axis of the view. A zoom module determines a third distance to be the distance between the first and second positions along the x-axis of the view if the first distance is greater than the second distance and the distance between the first and second positions along the y-axis of the view if the first distance is less than the second distance. Finally, the zoom module, in response to the second user input, moving the virtual camera relative to the three-dimensional environment according to the third distance and the greater of the first and second distances.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram illustrating a mobile device that can navigate through a three-dimensional environment using a multi-touch screen.

FIG. 2 is a diagram illustrating navigation in a three-dimensional environment.

FIGS. 3A-B are diagrams illustrating a pinch gesture using the major axis, according to an embodiment.

FIG. 4 is a flowchart illustrating a method for zooming in a three-dimensional environment using the major axis, according to an embodiment.

FIG. 5 is a diagram illustrating a pinch gesture that switches between major axes, according to an embodiment.

FIG. 6 is a diagram illustrating a system for zooming in a three-dimensional environment using the major axis, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments provide new user-interface gesture detection on a mobile device. In an embodiment, a user can zoom-in and zoom-out using a pinch on a mobile device having limited sensitivity to touch position along a minor axis of a gesture. In an example, multi-finger touch gestures, including a pinch zoom gesture, are detected along a major axis even if digits are not properly discriminated on a minor axis.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

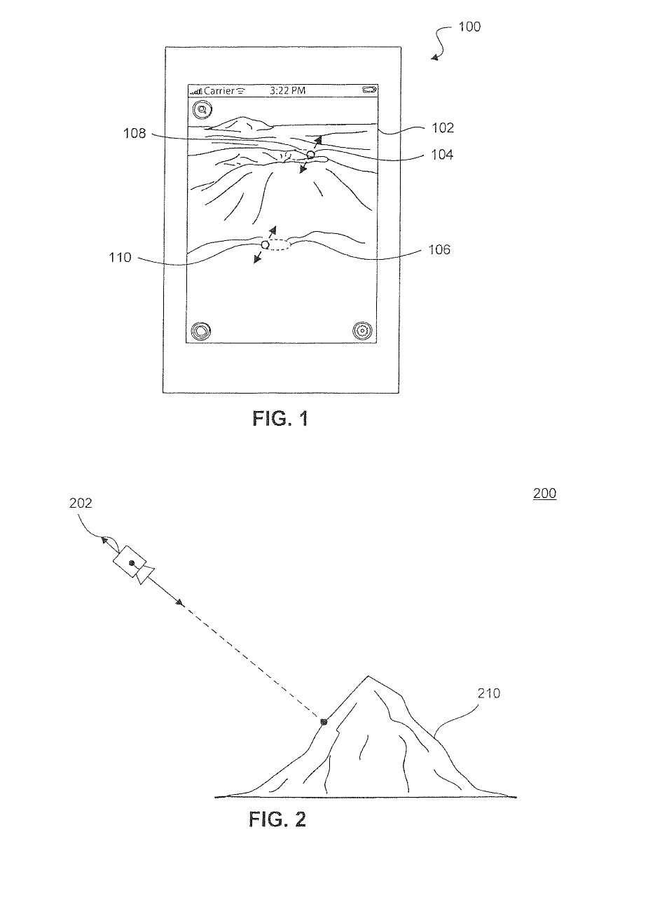

FIG. 1 is a diagram illustrating a mobile device 100 that can navigate through a three-dimensional environment using a multi-touch screen. In embodiments, mobile device 100 may be a PDA, cell phone, handheld game console or other handheld mobile device as known to those of skill in the art. In an example, mobile device 100 may be an IPHONE device, available from Apple Inc. In another example, mobile device 100 may be a device running an ANDROID platform, available from Google Inc. In other further embodiments, mobile device 100 may be a tablet computer, laptop computer, or other mobile device larger than a handheld mobile device but still easily carried by a user. These examples are illustrative and are not meant to limit the present invention.

Mobile device 100 may have a touch screen that accepts touch input from the user. As illustrated, mobile device 100 has a view 102 that accepts touch input when a user touches view 102. The user may touch the screen with his fingers, stylus, or other objects known to those skilled in the art. FIG. 1 shows that view 102 is being touched by objects (such as fingers) at positions 104 and 110. Some touch screens that accept multi-touch have low resolution. For example, some touch screens tend to merge their points of contact. In the example in FIG. 1, this tendency is illustrated by ovals 106 and 108.

Further, view 102 may output images to user. In an example, mobile device 100 may render a three-dimensional environment and may display the three-dimensional environment to the user in view 102 from the perspective of a virtual camera.

Mobile device 100 enables the user to navigate a virtual camera through a three-dimensional environment. In an example, the three-dimensional environment may include a three-dimensional model, such as a three-dimensional model of the Earth. A three-dimensional model of the Earth may include satellite imagery texture mapped to three-dimensional terrain. The three-dimensional model of the Earth may also include models of buildings and other points of interest. This example is merely illustrative and is not meant to limit the present invention.

FIG. 2 shows a diagram 200 illustrating navigation in a three-dimensional environment. Diagram 200 includes a virtual camera 202 oriented to face a hill 210 in the three-dimensional environment. In an example pinch zoom gesture, a user may touch her fingers to a screen of a mobile device. Moving her fingers away from each other may result in virtual camera 202 moving closer to hill 210, and moving her fingers closer together may result in virtual camera 202 moving away from hill 210. In this way, a user can apply a pinch gesture to view a broader or narrower perspective of the three-dimensional environment.

In an example, virtual camera 202 may move in proportion to the distance or speed in which the user moves her fingers closer together or farther apart. With low resolution touch screens such as illustrated in FIG. 1, a mobile device may have difficultly accurately determining the distance between the two figures. The inaccuracy in determining the distance between the two figures may cause the zoom gesture to also be inaccurate.

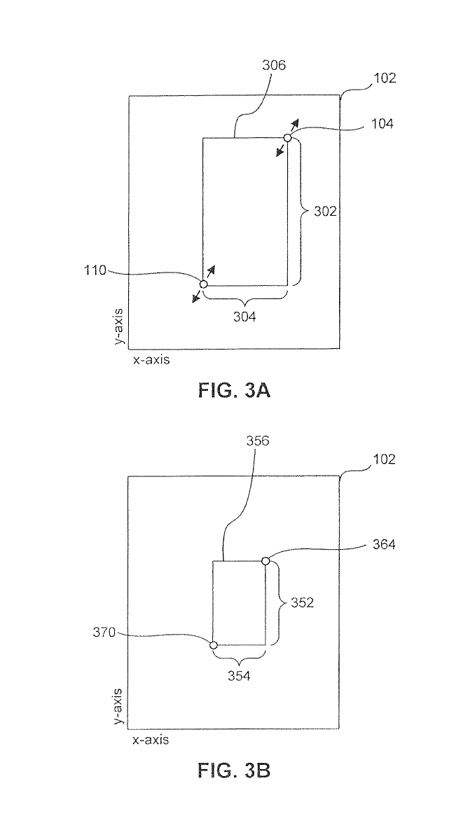

In dealing with inaccuracies of low resolution touch screens, embodiments navigate the virtual camera based on the major axis of a pinch gesture. FIGS. 3A-B are diagrams illustrating a pinch gesture using the major axis according to embodiments.

FIG. 3A shows view 102 with objects touching at positions 102 and 110 as described above. Positions 102 and 110 set the corners of a bounding box 306. Bounding box 306 is a box cornered by the positions of the user's fingers with sides running parallel to the x- and y-axes of view 102. In an embodiment, the x- and y-axes of view 102 may run parallel to the borders of view 102. Bounding box 306 includes a side 304 running parallel to the x-axis, and a side 302 running parallel to the y-axis. As side 302 along the y-axis is longer than side 304 along the x-axis, the y-axis is the major axis and the x-axis is the minor axis of bounding box 306.

In an embodiment, only the major axis component of the pinch gesture is used to navigate the virtual camera. Because the distance between the fingers is larger along the major axis than the minor axis, the contrast between the finger positions is higher and the touch screen is less likely to merge the two finger positions together. In this way, embodiments improve the smoothness and accuracy of pinch gestures. So, in FIG. 3A, only the y-axis component is used to navigate the virtual camera.

FIG. 3B shows view 102 with objects touching new positions 364 and 370. A user, in executing a pinch gesture, may move her fingers closer together. The user may move her finger from positions 104 and 110 in FIG. 3A to positions 364 and 370 in FIG. 3B. In an example operation, the mobile device may periodically sample the position of the of user's fingers on the touch screen. The mobile device may sample the user's fingers at positions 104 and 110 at a first time and mobile device may sample the user's fingers at positions 364 and 354 at a second, subsequent time.

The user's finger positions 364 and 370 set the corners of a bounding box 356.

Bounding box 356 includes a side 354 along the x-axis and a side 352 along the y-axis. Similar to as described for FIG. 3A, side 352 along the y-axis larger than side 354 along the x-axis. Therefore, the y-axis continues to be the major axis and the y-axis component is used to navigate the virtual camera.

In an embodiment, the pinch gesture may cause the virtual camera to zoom in or out. In that embodiment, the zoom factor may correspond linearly to the ratio of the size of side 352 to the size of side 302. In this way, the more the user pinches in or out, the more the virtual camera moves in and out.

In an embodiment, the zoom factor may be used to change the range between the virtual camera's focal point and focus point. That focus point may be a point of interest on the surface of the surface of the Earth or anywhere else in the three-dimensional environment. In an example, if the zoom factor is two thirds, then the distance between the virtual camera's focal point and focus point before the gesture is two thirds the distance between the virtual camera's focal point and focus point after the gesture.

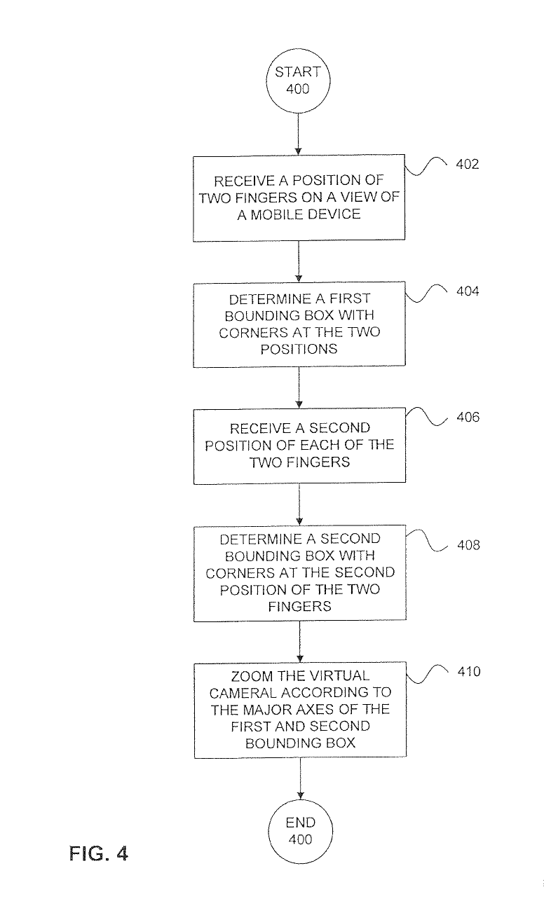

FIG. 4 is a flowchart illustrating a method 400 for zooming in a three-dimensional environment using the major axis, according to an embodiment.

Method 400 begins at a step 402. At step 402, a first user input is received indicating that two objects (e.g. fingers) have touched a view of the mobile device. In an embodiment, the first user input may include two positions and may indicate that a first finger has touched a first position and a second finger has touched a second position.

At step 404, a bounding box with corners located at the touch positions received at step 402 is determined. An example bounding box is described above with respect to FIG. 3A. The bounding box may include a side that runs parallel with the x-axis of the view and a side that runs parallel to the y-axis of the view. The bounding box may include major and minor axes. If the distance between the first and second touch positions along the x-axis is greater than the distance between the first and second touch positions along the y-axis, then the x-axis may be the major axis. Otherwise, the y-axis may be the major axis.

At step 406, a second user input is received indicating that the two objects have moved to new positions on the view of the mobile device. In an example, the second user input may indicate that the fingers have remained in contact with the touch screen but have moved to a new position on the touch screen. As mentioned above, the mobile device may periodically sample the touch screen and the second user input may be the next sample after receipt of the first user input.

At step 408, in response to receipt of the second user input, a second bounding box with corners at the positions received at step 406 may be determined. As described above for FIG. 3B, the major axis of that bounding box may be determined.

Also in response to receipt of the second user input, the virtual camera may zoom relative to the three-dimensional environment at step 410. The virtual camera may zoom by, for example, moving the virtual camera forward or backward. Alternatively, the virtual camera may zoom by changing a focal length of the virtual camera. The virtual camera may zoom by a factor determined according to the major axis of the first bounding box determined in step 404 and the major axis of the second bounding box determined in step 408. In an example, the zoom factor is computed as follows: factor=L(N)/L(N−1) where N represent the sequence of touch events and L(x) is the length of the major axis of the bounding box for a particular touch event x.

In an alternative embodiment, the major axes of the first and second bounding boxes may be used to determine a speed of the virtual camera. In response to receipt of the second user input, the virtual camera is accelerated to the determined speed. Then, the virtual camera is gradually decelerated. This embodiment may give the user the impression that the virtual camera has a momentum and is being decelerated by friction (such as air resistance).

As mentioned above, in an embodiment, the virtual camera is navigated according a change in the length of the major axis between two bounding boxes. In the example provided in FIGS. 3A-B, the major axis for both the first and second bounding boxes is the y-axis. However, in an embodiment, the major axis may change as the gesture transitions from the first to the second bounding box.

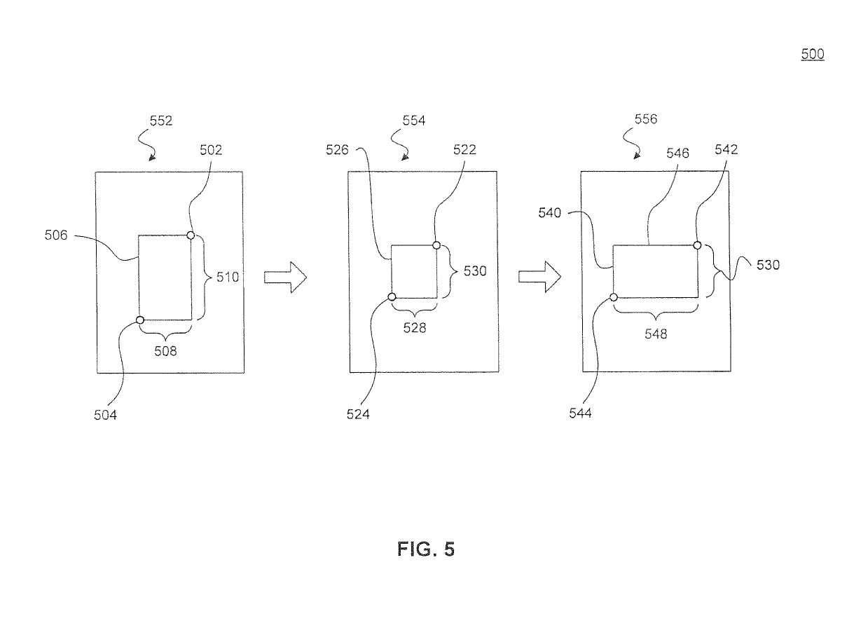

FIG. 5 shows a diagram 500 illustrating a pinch gesture such that the major axis transitions from the y-axis to the x-axis, according to an embodiment. To illustrate the pinch gesture, FIG. 5 shows a touch screen of a mobile at three different times at views 552, 554, and 556.

At view 552, a user has touched the screen at positions 502 and 504. Positions 502 and 504 form opposite corners of a bounding box 506. Bounding box 506 has a major axis side 510 along the y-axis of the view and a minor axis side 508 along the x-axis of the view.

At view 554, a user has moved her fingers to positions 522 and 524. Similar to view 552, positions 522 and 524 form opposite corners of a bounding box 526 with sides 528 and 530. Bounding box 506 is a square, and, accordingly, the length of side 528 and 530 are equal.

At view 556, a user has moved her fingers to positions 542 and 544. Similar to views 552 and 554, positions 542 and 504 form opposite corners of a bounding box 546. In contrast to bounding box 506, bounding box 546 has a major axis side 548 along the x-axis of the view and a minor axis side 530 along the y-axis of the view. In this way, in diagram 500, the user has moved her fingers such that the major axis is initially along the y-axis and transitions to be along the x-axis.

In an embodiment, a mobile device smoothly handles the input illustrated in diagram 500. For example, the mobile device may determine the major axis after receipt of each input and calculate the zoom factor using the determined major axis. In that example, if the mobile device first received the input illustrated in view 552 and then received the input illustrated in view 556, the zoom factor may be determined according to the ratio of the size of the major axis 510 along the x-axis and the size of major axis 548 along the y-axis. In this way, the mobile device continues to zoom in or out smoothly even if a user turns her fingers during a pinch gesture.

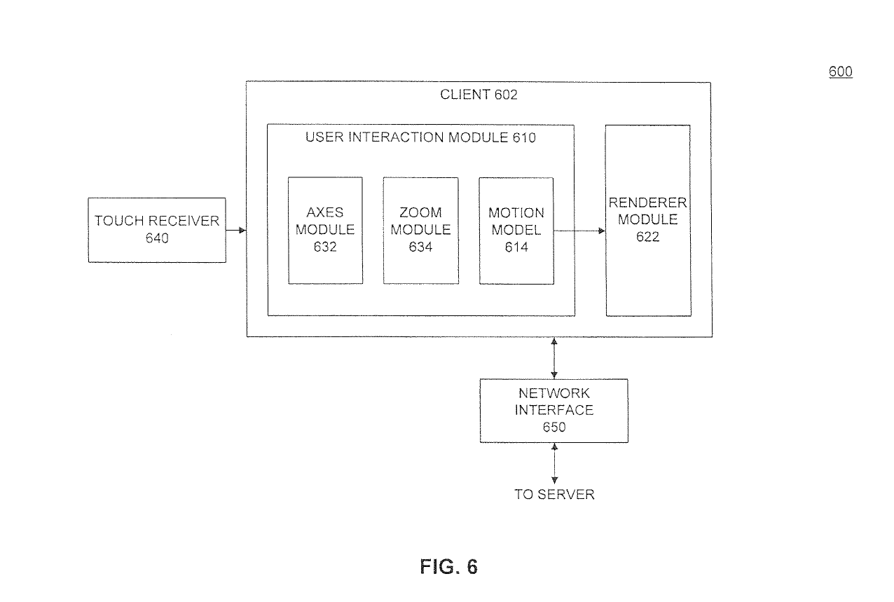

FIG. 6 is a diagram illustrating a system 600 for zooming in a three-dimensional environment using the major axis, according to an embodiment. System 600 includes a client 602 having a user interaction module 610 and a renderer module 622. User interaction module 610 includes a motion model 614. Client 602 receives input from a touch receiver 640 and can communicate with a server using a network interface 650.

In general, client 602 operates as follows. User interaction module 610 receives user input from touch receiver 640 and, through motion model 614, constructs a view specification defining the virtual camera. Renderer module 622 uses the view specification to decide what data is to be drawn and draws the data. If renderer module 622 needs to draw data that system 600 does not have, system 600 sends a request to a server for the additional data across one or more networks, such as the Internet, using network interface 650.

Client 602 receives user input from touch receiver 640. Touch receiver 640 may be any type of touch receiver that accepts input from a touch screen. Touch receiver 640 may receive touch input on a view such as the view 102 in FIG. 1. The touch input received may include a position that the user touched as defined by an X and Y coordinate on the screen. The user may touch the screen with a finger, stylus, or other object. Touch receiver 640 may be able to receive multiple touches simultaneously if, for example, the user selects multiple locations on the screen. The screen may detect touches using any technology known in the art including, but not limited to, resistive, capacitive, infrared, surface acoustic wave, strain gauge, optical imaging, acoustic pulse recognition, frustrated total internal reflection, and diffused laser imaging technologies.

In an embodiment, touch receiver 640 may receive two user inputs. For example, touch receiver 640 may sample inputs on the touch screen periodically. Touch receiver 640 may receive a first user input at a first sampling period, and may receive a second user input at a second sampling period. The first user input may indicate that two objects have touched a view of the mobile device, and the second user input may indicate that the two objects have moved to new positions.

Touch receiver 604 sends user input information to user interaction module 610 to construct a view specification. To construct a view specification, user interaction module 610 includes an axes module 632 and a zoom module 634.

Axes module 632 may determine the size of the major axis components for each of the inputs received by touch receiver 640. To determine the major axis, axes module may determine a bounding box and evaluate the x- and y-axis of the bounding box as described above. The larger of the x- and y-axis components constitutes the major axis component.

Zoom module 634 uses the relative sizes of the major axis components determined by axes module 632 to modify the view specification in motion model 614. Zoom module 634 may determine a zoom factor, and zoom the virtual camera in or out according to the zoom factor. As mentioned above, the zoom factor may correspond linearly to the ratio of the sizes of the first and second major axis components.

Motion model 614 constructs a view specification. The view specification defines the virtual camera's viewable volume within a three-dimensional space, known as a frustum, and the position and orientation of the frustum in the three-dimensional environment. In an embodiment, the frustum is in the shape of a truncated pyramid. The frustum has minimum and maximum view distances that can change depending on the viewing circumstances. Thus, changing the view specification changes the geographic data culled to the virtual camera's viewable volume. The culled geographic data is drawn by renderer module 622.

The view specification may specify three main parameter sets for the virtual camera: the camera tripod, the camera lens, and the camera focus capability. The camera tripod parameter set specifies the following: the virtual camera position (X, Y, Z coordinates); which way the virtual camera is oriented relative to a default orientation, such as heading angle (e.g., north?, south?, in-between?); pitch (e.g., level?, down?, up?, in-between?); yaw and roll (e.g., level?, clockwise?, anti-clockwise?, in-between?). The lens parameter set specifies the following: horizontal field of view (e.g., telephoto?, normal human eye—about 55 degrees?, or wide-angle?); and vertical field of view (e.g., telephoto?, normal human eye—about 55 degrees?, or wide-angle?). The focus parameter set specifies the following: distance to the near-clip plane (e.g., how close to the “lens” can the virtual camera see, where objects closer are not drawn); and distance to the far-clip plane (e.g., how far from the lens can the virtual camera see, where objects further are not drawn). As used herein “moving the virtual camera” includes zooming the virtual camera as well as translating the virtual camera.

As mentioned earlier, user interaction module 610 includes various modules that change the perspective of the virtual camera as defined by the view specification. In addition to motion model 614, user interaction module 610 includes an axes module 616 and a zoom module 612.

Each of the components of system 600 may be implemented in hardware, software, firmware, or any combination thereof. System 600 may be implemented on any type of computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for navigating virtual cameras in a three-dimensional environment, comprising:
(a) receiving, by a computing device having a touch screen, a first user input indicating that first and second objects have touched a view of the computing device, wherein the first object touched the view at a first position and the second object touched the view at a second position;
(b) determining, by the computing device, a first distance between the first and second positions along an x-axis of the view;
(c) determining, by the computing device, a second distance between the first and second positions along a y-axis of the view, the greater of the first and second distances corresponding to a first major axis distance;
(d) receiving, by the computing device, a second user input indicating that the first and second objects have moved to new positions on the view of the computing device, wherein the first object moved to a third position on the view and the second object moved to a fourth position on the view;
(e) determining, by the computing device, a third distance between the third and fourth positions along the x-axis of the view;
(f) determining, by the computing device, a fourth distance between the third and fourth positions along the y-axis of the view, the greater of the third and fourth distances corresponding to a second major axis distance
(g) in response to the second user input, moving, by the computing device, a virtual camera relative to the three-dimensional environment as a function of the first and second major axis distances,
wherein the virtual camera is moved such that a distance between a focal point of the virtual camera and a focus point of the virtual camera changes by a factor corresponding to a ratio of the second major axis distance to the first major axis distance.

2. The method of claim 1, wherein the moving (g) comprises moving the virtual camera at a speed determined as a function of the second major axis distance and the first major axis distance.

3. The method of claim 2, further comprising gradually decreasing the speed at which the virtual camera is being moved.

4. (canceled)

5. The method of claim 1, wherein the first and second objects are fingers.

6. The method of claim 1, wherein. the three-dimensional environment comprises a three-dimensional model of the Earth.

7. The method of claim 1, wherein the touch screen of the computing device captures touch input at a low resolution such that the lesser of the first distance determined in (b) and the second distance determined in (c) is less accurate than the greater of the first distance determined in (b) and the second distance determined in (c).

8. The method of claim 1, wherein the computing device samples touch input periodically and the receiving (a) occurs during a first sample period and the receiving (d) occurs during the next sample period after the first sample period.

9. (canceled)

10. A system for navigating in a three-dimensional environment, comprising:
a computing device including a touch receiver configured to receive a first input indicating that first and second objects have touched a view of the computing device, wherein the first object touched the view at a first position and the second object touched the view at a second position, the touch receiver being further configured to receive a second user input indicating that the first and second objects have moved to new positions, different from the positions in the first user input, on the view of the computing device, wherein the first object moved to a third position on the view and the second object moved to a fourth position on the view, the computing device further including one or more processors and associated memory, the memory storing instructions that, when executed by the one or more processors, configure the computing device to implement:
a motion model that specifies a virtual camera to indicate how to render the three-dimensional environment for display;
an axes module that determines:
a first distance between the first and second positions along an x-axis of the view;
a second distance between the first and second positions along a y-axis of the view, the greater of the first and second distances corresponding to a first major axis distance;
a third distance between the third and fourth positions along the x-axis of the view; and
a fourth distance between the third and fourth positions along the y-axis of the view, the greater of the third and fourth distances corresponding to a second major axis distance; and
a zoom module that:
in response to the second user input, moves the virtual camera relative to the three-dimensional environment as a function of the first and second major axis distances,
wherein the zoom module moves the virtual camera such that a distance between a focal point of the virtual camera and a focus point of the virtual camera change by a factor corresponding to a ratio of the second major axis distance to the first major axis distance.

11. The system of claim 10, wherein the movement provided by the zoom module corresponds to a zooming of the view of the virtual camera.

12. The system of claim 10, wherein the zoom module is further configured to determine a speed as a function of the second major axis distance and the first major axis distance and move the virtual camera at the determined speed.

13. The system of claim 12, wherein the zoom module is further configured to decelerate the speed at which the virtual camera is being moved.

14. The system of claim 10, wherein the first and second objects are fingers.

15. The system of claim 10, wherein the three-dimensional environment comprises a three-dimensional model of the Earth.

16. The system of claim 10, wherein the touch receiver of the computing device captures touch input at a low resolution such that the computing device is unable to accurately determine the lesser of the first and second distances.

17. The system of claim 10, wherein the computing device samples touch input periodically and the touch receiver receives the first user input during a first sample period and the touch receiver receives the second user input during the next sample period after the first sample period.

18. (canceled)

19. (canceled)

20. A computer-implemented method for navigating virtual cameras in a three-dimensional environment, comprising:
(a) receiving, by a computing device having a touch screen, a first user input indicating that first and second objects have touched a view of the computing device, wherein the first object touched the view at a first position and the second object touched the view at a second position;
(b) determining, by the computing device a first rectangular hounding box with corners at the first and second positions and sides running parallel to the sides of the view, the first rectangular bounding box defining a first distance along an x-axis of the view and a second distance along a y-axis of the view, the greater of the first and second distances corresponding to a first major axis distance;
(d) receiving, by the computing device, a second user input indicating that the first and second objects have moved to new positions on the view of the computing device, wherein the first object moved to a third position on the view and the second object moved to a fourth position on the view;
(e) determining, by the computing device, a second rectangular bounding box with corners at the third and fourth positions and sides running parallel to the sides of the view, the second rectangular bounding box defining a third distance along the x-axis of the view and a fourth distance along the y-axis of the view, the greater of the third and fourth distances corresponding to a second major axis distance;
(g) in response to the second user input, moving, by the computing device, a virtual camera relative to the three-dimensional environment as a function of the first and second major axis distances
wherein the virtual camera is moved such that a distance between a focal point of the virtual camera and a focus point of the virtual camera changes by a factor corresponding to a ration of the second major axis distance to the first major axis distance.

21. (canceled)

22. The method of claim 20, further comprising determining a speed as a function of the second major axis distance and the first major axis distance, wherein the moving (g) comprises moving the virtual camera relative to the three-dimensional environment at the determined speed.

23. The method of claim 22, further comprising gradually decreasing the speed at which the virtual camera is being moved.
